(19) United States
(12) Patent Application Publication
(10) Pub. No.: US 2026/0212418 A1
(43) Pub. Date: Jul. 23, 2026

(54) SYSTEMS, METHODS, AND MEDIA FOR GENERATING AN ELECTRONIC DIGITAL TWIN FOR AN ASSET USING ARTIFICIAL INTELLIGENCE

(71) Applicant: FMR LLC, Boston, MA (US)

(72) Inventor: Lee Gondorchin, Spring, TX (US)

(21) Appl. No.: 19/033,926

(22) Filed: Jan. 22, 2025

(51) Int. Cl. G06Q 40/06; G06F 3/04815

(52) U.S. Cl. CPC G06Q 40/06; G06F 3/04815

(57) ABSTRACT

Techniques are provided for generating a digital twin for an asset using artificial intelligence. Input information associated with a user of an enterprise and/or an asset of interest to the user may be received. A trained generative AI model may generate a digital twin of the asset using the input information. The digital twin may include a visual representation of the asset that is divided into a plurality of components (e.g., visual features) and underlying data that is linked to the visual representation and that is used to determine which of the components are included in the visual representation when the visual representation is displayed. The underlying data of the digital twin and other factors may be analyzed at one or more different times. Based on the analysis, it can be determined which visual features are included when the visual representation of the digital twin for the asset is displayed.

### BACKGROUND

### Technical Field

The present disclosure relates generally to electronic digital twins for assets, and more specifically for techniques for generating an electronic digital twin for an asset using artificial intelligence.

### Background Information

In the financial technology (fintech) space, digital twins are typically virtual replicas of financial systems, portfolios, or individual user behaviors, enabling financial organizations to simulate, analyze, and optimize their operations in real time. These digital twins are created using extensive data, such as transactional records, market trends, and customer interactions. Financial institutions use digital twins to simulate behaviors of their organization or customers based on this data. The simulated behaviors are then leveraged to predict outcomes, assess risks, and model different scenarios without impacting real-world systems. For instance, a digital twin of a trading portfolio can simulate market conditions to forecast potential returns or identify vulnerabilities in investment strategies.

Conventional fintech digital twins can model individual customer behaviors by creating data-driven virtual replicas that reflect a customer's financial activities, preferences, and decision-making patterns. These models can be developed using a combination of historical data, such as transaction records, spending habits, and credit histories, along with real-time inputs like online interactions and responses to financial products. By simulating customer behavior, digital twins enable financial institutions to predict future actions, identify needs, and deliver personalized services. In the fintech space, conventional digital twins are primarily used as predictive models, helping financial institutions make informed decisions to enhance customer retention and satisfaction.

However, these conventional fintech digital twins in the technological area of digital modeling and simulations are often designed to optimize the behavior and strategies of the financial institution—such as improving service offerings or risk management—rather than directly influencing or modifying the customer's behavior.

### SUMMARY

Techniques are provided for generating an electronic digital twin for an asset using artificial intelligence.

Specifically, a processor (e.g., a processor executing a digital twin generating module and/or a generative AI model) may receive input information associated with a user of an enterprise and/or an asset of interest to the user. For example, a customer of the enterprise may use an application executing on a client device to provide the input information to the processor. The input information may include, but is not limited to, an identifier of an asset of interest to a user, a financial goal amount (e.g., cost) the user would like to save towards acquiring (e.g., purchasing) the asset of interest, a start date on which the user would like to start accumulating finances towards the financial goal amount, and an end date on which the user desires to reach the financial goal amount.

A generative AI model may receive the input information. The generative AI model may be trained using a large dataset of images of various objects (i.e., components) of different assets, where each object is paired with detailed text annotations describing the objects and their features. The trained generative AI model may use the received input information to generate a digital twin for the asset. In an embodiment, the digital twin generated by the generative AI model may include a visual representation of the asset that is divided into a plurality of components (e.g., visual features) and underlying data that is linked to the visual representation and that is used to determine which of the components are included in the visual representation when the visual representation is displayed.

The visual representation of the digital twin may be displayed to the user and the visual representation of the digital twin can be updated until the visual representation of the digital twin is acceptable to the user. Once the visual representation of the digital twin is acceptable, the digital twin may be stored on enterprise storage. As such, the visual representation and thus the digital twin according to the one or more embodiments as described herein is customizable and user dynamic.

After the digital twin is generated and stored, the processor can analyze the underlying data of the digital twin and other factors related to the customer/asset at one or more different times. Based on the analysis, the processor can determine which visual features are included when the visual representation of the asset is displayed on the display screen of the client device. Therefore, the visual representation of the digital twin according to the one or more embodiments as described herein can simulate or represent the user's progress towards the goal to acquire the asset.

For example, if the visual representation of the digital twin for the asset only includes a single visual feature, the visual representation may signify or indicate that the user's financial accumulation progress towards the cost to acquire the asset is minimal. However, if the visual representation of the digital twin for the asset includes most (e.g., but not all) of the visual features, the visual representation may signify or indicate that the user's financial accumulation progress is close to the cost needed to acquire the asset. Additionally, the processor may, based on the analysis, supplement the visual representation with other graphics and/or markings that can be utilized for incentivization or to convey other meanings.

### BRIEF DESCRIPTION OF THE DRAWINGS

The description below refers to the accompanying drawings, of which:

FIG. 1 is a high-level block diagram of an example system environment according to one or more embodiments as described herein;

FIG. 2 is a flow diagram of a sequence of steps for generating a digital twin according to the one or more embodiments as described herein;

FIG. 3 is an example digital twin generated for a pickup truck using generative AI model according to the one or more embodiments as described herein;

FIG. 4 is an example visual representation of a digital twin for the pickup truck when the financial goal amount is reached according to the one or more embodiments as described herein;

FIGS. 5, 6, and 7 together are a flow diagram of a sequence of steps for analyzing underlying data of a digital twin and other information to determine how a visual representation of the digital twin is displayed according to the one or more embodiments as described herein;

FIG. 8 is an example visual representation of a digital twin for the pickup truck without an incentive visual feature according to the one or more embodiments as described herein;

FIG. 9 is an example visual representation of a digital twin for the pickup truck with an incentive visual feature according to the one or more embodiments as described herein;

FIG. 10 is an example visual representation of a digital twin for the pickup truck with a visual feature of an issue and an incentive visual feature according to the one or more embodiments as described herein; and

FIG. 11 is an example visual representation of a digital twin for the pickup truck with a visual feature of an issue according to the one or more embodiments as described herein.

### DETAILED DESCRIPTION OF AN ILLUSTRATIVE EMBODIMENT

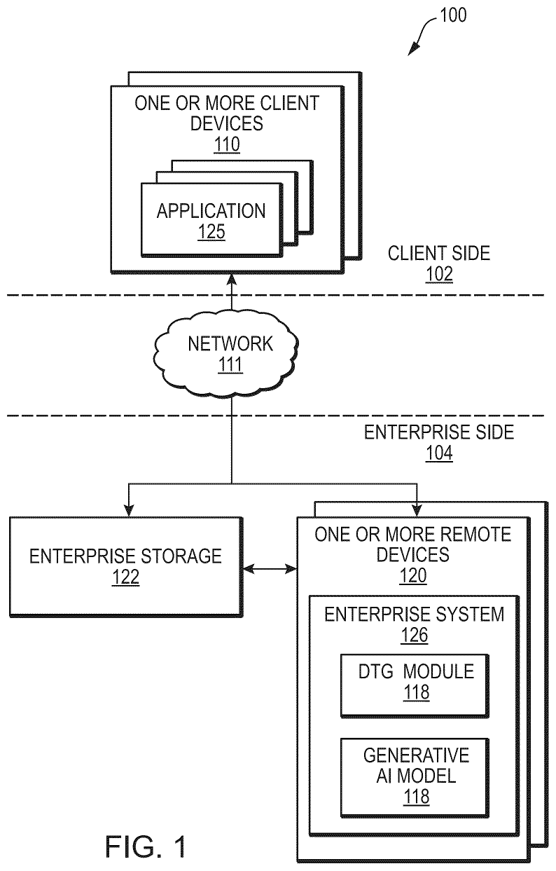

FIG. 1 is a high-level block diagram of an example system environment 100 according to one or more embodiments as described herein. The system environment 100 may be divided into a client side 102 that includes one or more local client devices 110 that are local to end users, and an enterprise side 104 that includes one or more remote devices 120 and enterprise storage 122 that are remote from the end users. Enterprise side 104 may be managed, operated, and maintained by an enterprise. In an embodiment, the enterprise of enterprise 104 side may be a financial services institution.

The client side 102 may include one or more local client devices 110 that provide a variety of user interfaces and non-processing intensive functions. For example, a local client device 110 may provide a user interface, e.g., a graphical user interface and/or a command line interface, for receiving user input and displaying output according to the one or more embodiments as described herein. In an embodiment, the client device 110 may be a server, a workstation, a platform, a mobile device, a network host, or any other type of computing device. The client device 110 may be operated by, for example, customers of the enterprise. The client device 110 may also be operated by authorized personnel, e.g., employees of the enterprise, to perform enterprise functions. For example, client device 110 may download and execute application 125 that is provided by the enterprise. The execution of application 125 may allow customers and/or employees of the enterprise to implement one or more financial services functions.

The client device 110 may communicate with the enterprise system 126, managed/operated by the enterprise, over network 111. For example, a user may utilize application 125, executing on client device 110, to perform one or more functions at enterprise system 126 as will be described in further detail below. In an embodiment, the application 125 may utilize one or more application program interfaces (APIs) to make requests and receive responses from the enterprise side 104. In an embodiment, the application 125 may utilize websockets for low-latency communications with the enterprise side 104.

Enterprise side 104 includes enterprise storage 122 that may store one or more data structures that may be generated or utilized according to the one or more embodiments as described herein. For example, enterprise storage 122 may store one or more different electronic digital twins, generated according to the one or more embodiments as described herein, for each customer of the enterprise. Additionally, enterprise storage may store one or more models, input data, etc. that may be utilized according to the one or more embodiments as described herein.

The enterprise side 104 also includes one or more remote devices 120 that may be one or more cloud-based devices and/or one or more server devices. The one or more remote devices 120 may store and execute enterprise system 126 that may implement the one or more embodiments as described herein. The enterprise system 126 may be accessible to its customers and/or authorized personnel, e.g., employees of the enterprise. The enterprise system 126 includes digital twin generating (DTG) module 118 and generative artificial intelligence (AI) model 119 that may implement the one or more embodiments as described herein.

In an embodiment, only authorized personnel of the enterprise can access and/or execute the DTG module 118 and/or generative AI model 119 to implement the one or more embodiments as described herein. For example, authorized personnel of the enterprise may utilize client device 110 to execute DTG module 118 and/or generative AI model 119.

As will be described in further detail below, DTG module 118 and generative AI model 119 may together generate a user (e.g., customer) specific digital twin that includes a visual representation of an asset of interest and underlying data that dictates how the visual representation of the digital twin is displayed on a computer display screen. For example, the DTG module 118 may receive input data identifying an asset of interest to the user and/or other information associated with the asset and/or the user. The DTG module 118 may provide the input information to the generative AI model 119 that may generate the digital twin for the asset, wherein the visual representation of the digital twin for the asset is divided into a plurality of different visual features. The DTG module 118 may display the visual representation of the asset with a selected number of the plurality of different visual features based on the financial progress of the user towards the cost (i.e., financial goal amount) to acquire the real-world asset.

That is, the visual representation of the digital twin is adaptable and can change over time based on the underlying data of the digital twin. Therefore, the visual representation of the digital twin according to the one or more embodiments as described herein can simulate or represent the user's progress towards the goal to acquire the asset.

As a result, the digital twin according to the one or more embodiments as described herein can be utilized to directly influence and/or modify the customer's behavior. For example, if the visual representation only includes a single feature because the user's financial progress towards the cost to acquire the asset is minimal, the visual representation with the single feature may motivate the user to alter his/her spending behavior such that the financial progress advances more drastically in the immediate future. Moreover, the digital twin according to the one or more embodiments as described herein can be generated on-demand and for any of a variety of different users that may, for example, have different financial situations such that the financial progress towards the cost progresses differently overtime. Thus, the digital twin according to the one or more embodiments as described herein is user dynamic, as its configuration depends on user-specific factors (e.g., user finances over time).

This is in sharp contrast to conventional fintech digital twins that are often designed to optimize the behavior and strategies of the financial institution-such as improving service offerings or risk management-rather than directly influencing or modifying the customer's behavior. As such, the user dynamic digital twin that is generated and utilized (e.g., displayed) according to the one or more embodiments as described herein is different and improved when compared to conventional digital twins. Accordingly, the one or more embodiments as described herein provide an improvement in the existing technological field of digital modeling and simulations.

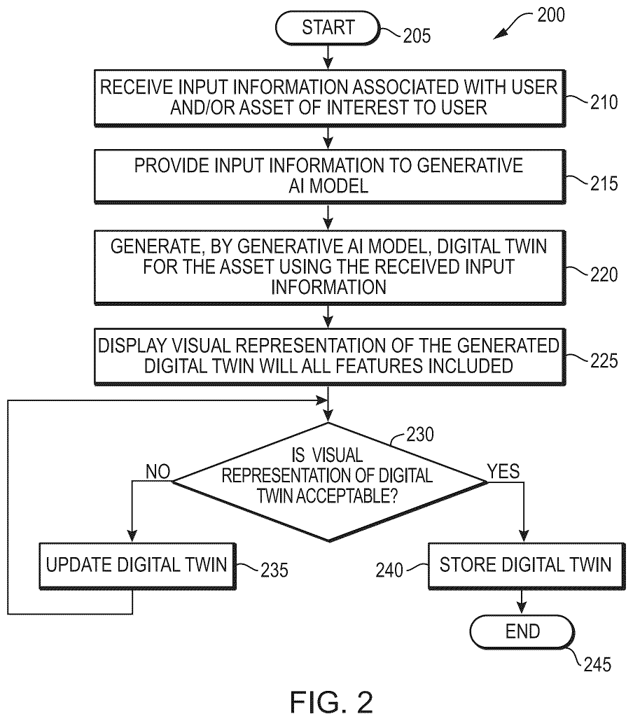

FIG. 2 is a flow diagram of a sequence of steps for generating a digital twin according to the one or more embodiments as described herein. The procedure of FIG. 2 starts at step 205 and continues to step 210. At step 210, the DTG module 118 receives input information associated with a user and/or an asset of interest to the user. In an embodiment, the DTG module 118 may receive the input information from client device 110 over network 111. For example, a customer of the enterprise may utilize client device 110 to first provide authentication information (e.g., username and password) to gain access to the enterprise system 126. After authentication, the customer may utilize client device 110 to provide the input information to the DTG module 118. Alternatively, the user may utilize client device 110 to store the input information at enterprise storage 122. The DTG module 118 may then obtain the input information from enterprise storage 122.

The input information may include, but is not limited to, an identifier of an asset of interest to a user, a financial goal amount (e.g., cost) the user would like to save towards acquiring (e.g., purchasing) the asset of interest, a start date on which the user would like to start accumulating finances towards the financial goal amount, and an end date on which the user desires to reach the financial goal amount.

As an illustrative example in relation to FIG. 2, let it be assumed that customer John Doe of a financial services enterprise utilizes client device 110 on Jan. 1, 2024, after authentication, to indicate that an asset of interest is a pickup truck that is produced by Alpha Company. Further, let it be assumed that John Doe utilizes client device 100 to indicate that the financial goal amount is $80,000, the start date is Feb. 1, 2024, and the end date is Oct. 1, 2024. Specifically, let it be assumed for this example that the cost to purchase the pickup truck is $100,000, but that John will be obtaining a $20,000 car loan towards the pickup truck. As such, John determines that he will be required to save $80,000 by Oct. 1, 2024, to purchase the pickup truck produced by Alpha Company by the end of 2024. Although the example with relation to FIG. 2 refers to a pickup truck, it is expressly contemplated that the one or more embodiments as described herein are applicable to any asset of interest to a user. For example, the asset may be saving for the college education of John Doe's child. Therefore, the reference to a pickup truck is for illustrative purposes only.

The procedure continues from step 210 to step 215. At step 215, the DTG module 118 provides the input information to generative AI model 119. For example, the DTG module 118 may transmit the input information to generative AI model 119. Alternatively, the input information may be stored at enterprise storage 122, and generative AI model 119 may obtain the input information from enterprise storage 122. The procedure continues from step 215 to step 220. At step 220, generative AI model 119 generates a digital twin for the asset using the received input information.

In an embodiment, generative AI model 119 can generate content (e.g., digital twin) based on received input information and learned patterns. For example, generative AI model 119 may be a trained model that can generate a digital twin of the asset based on the received input information and according to the one or more embodiments as described herein.

In an embodiment, generative AI model 119 may be trained to create the visual representation (e.g., image or 3D model) of the digital twin using the input information, wherein the visual representation of the asset is divided into a plurality of visual features (components) that make up the entirety of the visual representation of the asset. In an embodiment the visual representation may be a two-dimensional graphical depiction of the asset, (2) a three-dimensional graphical depiction of the asset, (3) an augmented reality model that includes a graphical depiction of asset, or (4) a virtual reality model that includes the graphical depiction of the asset.

In an embodiment, generative AI model 119 may be trained using a large dataset of images of various objects (i.e., components) of different assets, where each object is paired with detailed text annotations describing the objects and their features. For example, the dataset might include images of pickup trucks with labeled components such as “hood,” “truck bed,” “doors,” and “lights,” along with descriptive annotations that specify their spatial relationships and attributes, like “a truck with a bed,” “a truck with four doors,” or “a truck with two doors and headlights.”

These annotations provide the generative AI model 119 with the semantic and spatial context needed to learn how individual components appear and how they are arranged relative to one another for generating the visual representation of the asset. This detailed pairing of text and imagery forms the foundation for training generative AI model 119 to generate accurate and feature-rich images or models based on underlying data of the visual twin as will be described in further detail below.

In an embodiment, generative AI model 119 may be based on a transformer or diffusion approach and may be configured to process text input by converting it into an intermediate representation, which is then used to generate an image or model. In an embodiment, generative AI model 119 may use a “loss function” to evaluate how well the generated image aligns with the input text, refining its predictions over successive training iterations to improve accuracy. This process enables generative AI model 119 to learn associations between textual descriptions and the visual appearance of an asset and its components.

After sufficient training, generative AI model 119 can generate detailed and realistic images or models based on textual input. For example, when the provided input information is “pickup truck,” the generative AI model 119 can infer from its training that an image of a pickup truck should include a variety of features such as a hood, doors, lights, a roof, and a bed, all accurately represented with correct proportions and relative positions in the image.

Although the description includes a particular manner in which generative AI model 119 may be trained to generate different visual representations of an asset, it is expressly contemplated that generative AI model 119 may be trained in any of a variety of different ways.

Generative AI model 119 that is trained as described above can generate a digital twin with one or more visual features according to the one or more embodiments as described herein. As described herein, the digital twin generated by generative AI model 119 may include a visual representation of the asset that is divided into a plurality of components (e.g., visual features) and underlying data that is linked to the visual representation and that is used to determine which of the components are included in the visual representation when the visual representation is displayed. The visual representation of the digital twin according to the one or more embodiments as described herein may be a combination of the visual features of an asset (e.g., the style of the grill of the pickup truck) and the structural features (e.g., chassis) for the asset.

According to the one or more embodiments as described herein, the digital twin may represent material wealth and the asset in a similar manner as the actual asset represents material wealth. For example, a digital twin of a pickup truck may signify or indicate the material wealth of the user that owns the digital twin in a similar manner that the actual pickup truck represents the material wealth of the user that owns the pickup truck.

Continuing with the example, the generative AI model 119, which is trained as described herein, may receive input information that indicates that the asset of interest to the user is a pickup truck and the financial goal amount is $80,000. Based on the financial goal amount, the generative AI model 119 may determine that a dividing factor should be eight. Therefore, the financial goal amount is divided into eight equal portions of $10,000. Accordingly, the generative AI model 119 may divide the visual representation of the pickup truck into eight selected visual features using the plurality of different visual features, with their proportions and spatial relationships, that are learned and identified by generative AI model 119.

Specifically, and as described above, generative AI model 119 may infer from its training that an image of a pickup truck should include a variety of features such as a hood, doors, lights, a roof, and a bed, all accurately represented with correct proportions and relative positions in the image. Based on the determination that the visual representation of the pickup truck will be divided into eight different visual features, the generative AI model 119 may select eight particular features from all the visual representation of the pickup truck that are identified by generative AI model 119 based on its training.

In this example, let it be assumed that generative AI model 119 selects the following eight visual features for the visual representation of the pickup truck: (1) chassis (i.e., frame), (2) engine, (3) body (4) wheels, (5) hood, (6) doors, (7) side mirrors, (8) headlights. Each of the eight features may have a corresponding label or identifier to differentiate the feature from the other features. Each visual feature may be stored with a corresponding value/identifier that indicates whether the visual feature should be included in the visual representation when the visual representation is displayed on, for example, a display screen of client device 110 as will be described in further detail below.

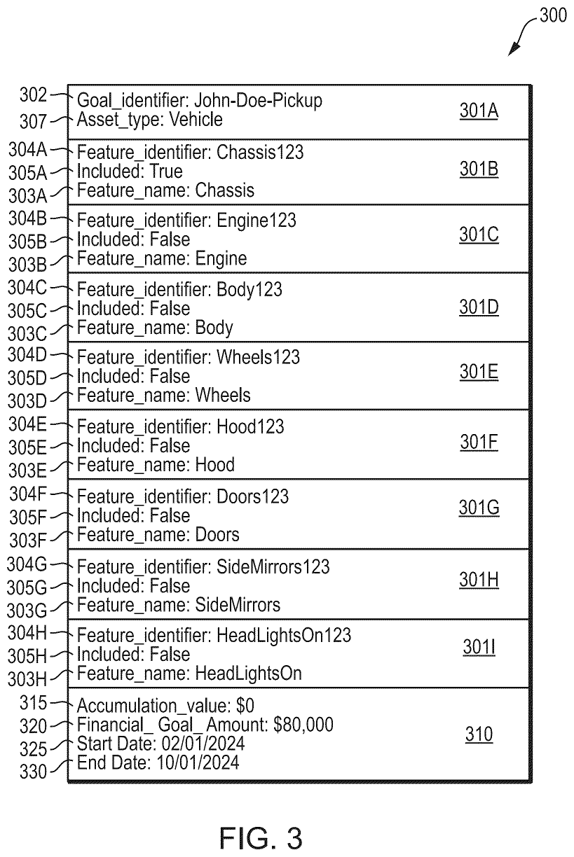

FIG. 3 is an example digital twin generated for a pickup truck using generative AI model 119 according to the one or more embodiments as described herein. The digital twin 300 of FIG. 3 may include eight different visual features for the visual representation of the pickup truck and underlying data linked to the visual representation that is used to determine which features are included when the visual representation is displayed on client device 110.

Digital twin 300 may include section 301A that includes information corresponding to digital twin 300 for the pickup truck of interest to John Doe. Specifically, section 301A includes goal identifier field 302 that stores a unique identifier for digital twin 300 that is generated for John Doe based on the provided input information. In this example, goal identifier field 302 stores an identifier of “John-Doe-Pickup”. The identifier in goal identifier field 302 may differentiate digital twin 300 from other digital twins that are generated for John Doe and/or for other users/customers according to the one or more embodiments as described herein. Section 301A also includes an asset type field 307 that indicates that the type of asset of interest is a vehicle. The digital twin 300 for the pickup truck is divided into the visual features of (1) chassis (i.e., frame), (2) engine, (3) body (4) wheels, (5) hood, (6) doors, (7) side mirrors, (8) headlights. Each of the eight visual features and corresponding information may be stored in sections 301B-301I. For example, section 301B corresponds to the chassis, section 301C corresponds to the engine, and so forth. Each section may include a feature name field 303 (e.g., 303A-303H) that stores the name of the corresponding visual feature (e.g., chassis, engine, etc.).

Additionally, each section may include a feature identifier field 304 (e.g., 304A-304H) that stores an identifier of the corresponding feature. In an embodiment, the feature identifier may be a link or pointer to a file for the visual feature. For example, the feature identifier of ‘Chassis123” in section 301B may be a link or pointer to a file for the visual representation of the chassis that may be stored in enterprise storage 122. Therefore, and in this embodiment, the digital twin 300 includes a link or pointer to a visual representation for each of the eight different features that make up the visual representation of the pickup truck.

Therefore, when the visual representation of the pickup truck is to be displayed on the display of client device 100 with the chassis, the file of the chassis may be obtained from enterprise storage 122 to display the chassis on the client device 110.

Alternatively, the feature identifier may in fact be the file name of the file that is stored in feature identifier field 304. For this alternative embodiment, the feature identifier of “Chassis123” may be the file name of the file, which includes the visual representation of the chassis, that is in fact stored in section 301B of digital twin 300. Therefore, and in this alternative embodiment, the digital twin 300 includes the visual representations of each of the eight different features that make up the visual representation of the pickup truck. This alternative embodiment utilizes increased storage space when compared to the embodiment that utilizes a link or a pointer. However, the alternative embodiment allows the digital twin 300 to be self-contained and more easily shared and exported between different platforms, for example.

In an embodiment, a file for each feature linked to or stored in feature identifier field 304 is in a format that is consistent with the type of model/image used for displaying the visual representation of the pickup truck on the display of client device 110. For example, if the visual representation of the pickup truck is to be displayed as a 3D model, each file for the eight different visual features may be in a Stereolithography (STL) format. If, for example, the visual representation of the pickup truck is to be displayed as a 2D model, each image of the eight different visual features may be in a Joint Photographic Experts Group (JPEG) format. For the example in relation to FIG. 3, let it be assumed that each of the eight features is a JPEG file.

Additionally, each section for a feature may have an included field 305 that stores an identifier indicating whether the corresponding feature is to be included in the visual representation of the pickup truck when the pickup truck is displayed. In an embodiment, an identifier of “false” may indicate that the feature should not be included in the visual representation when the visual representation is displayed, while a value of “true” may indicate that the feature should be included in the visual representation when the visual representation is displayed.

Digital twin 300 of FIG. 3 also includes section 310 with the input information (i.e., underlying data) associated with the user/asset and that is utilized to determine which of the different features in section 301 are included in the visual representation when displayed. Specifically, the input information in section 310 includes an accumulation value field 315 that indicates that the accumulation value is $0. The input information also includes a financial goal amount field 320 that includes the financial goal amount of $80,000 for the pickup truck. The input information also includes the start date field 325 that stores the start date of Feb. 1, 2024, and the end date field 330 that stores the end date of Oct. 1, 2024.

For the example in relation to FIG. 3, the accumulation value is $0, which is the lowest possible value. Accordingly, the one or more embodiments as described herein may only display one default feature of all the eight visual features to signify or indicate that the accumulation value is at the starting lowest value and far away from the financial goal amount of $80,000. Therefore, and in this example of FIG. 3, only section 301B for the chassis feature has an included identifier field 304A with a value of true, and each of the other included identifier fields 304B-304H for the other visual features of digital twin 300 has an included identifier value of false. Therefore, and when the visual representation of the digital twin 300 for the pickup truck is displayed on client device 110 when the accumulation value is $0, only the chassis of the pickup truck is included when the visual representation of the displayed pickup truck.

As will be described in further detail below, as the accumulation value changes between the starting value of $0 and the financial goal amount of $80,000 and as other factors come into play, the one or more embodiments as described herein can adapt the visual representation of the pickup truck using one or more of the eight visual features when displaying the visual representation of digital twin 300. For example, when the accumulation value reaches $20,000 or $30,000, the one or more embodiments as described herein can adapt the visual representation of the digital twin 300 for the pickup truck by displaying two or three additional visual features (e.g., engine, body, wheels) instead of a single feature to signify/indicate progress towards the financial goal amount of $80,000.

Therefore, the DTG module 118 can analyze the underlying data of the digital twin 300 to determine how the visual representation of the digital twin 300 is displayed. Additionally, and because the underlying data of the digital twin is user specific, the display of the visual representation of each digital twin generated according to the one or more embodiments as described herein is user dynamic.

Referring back to FIG. 2, the procedure continues from step 220 to step 225. At step 225, the DTG module 118 displays the visual representation of the generated digital twin with all the features included to illustrate what the visual representation of the asset will look like when the financial goal amount is reached. In this example, the DTG module 118 displays on client device 110 the visual representation of digital twin 300 for the pickup truck with all eight visual features.

Based on the display on client device 110, John Doe can see what the visual representation of digital twin 300 will look like when he reaches the financial goal amount of $80,000 to acquire the pickup truck. Additionally, the DTG module 118 may display information corresponding to the asset and underlying information. For example, the DTG module 118 can also display one or more of (1) the current value of the accumulation value, (2) the financial goal amount, the (3) start date, and (4) the end date, and/or (5) a listing of the visual features.

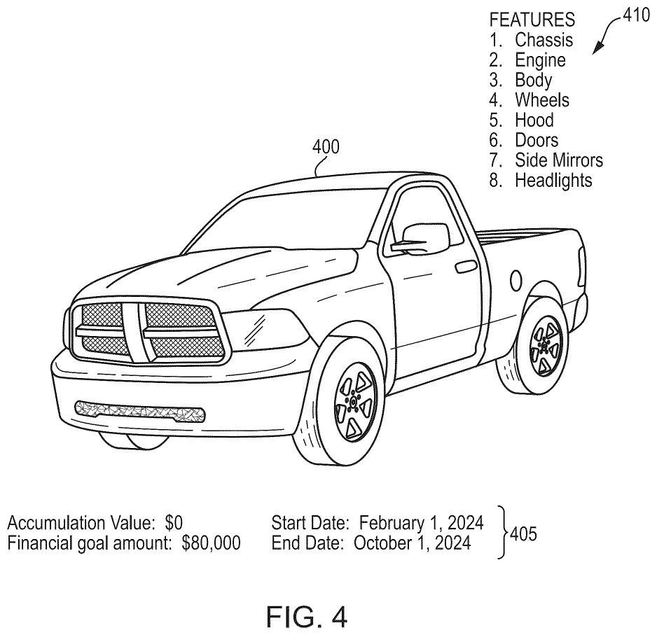

FIG. 4 is an example visual representation of digital twin 300 for the pickup truck when the financial goal amount is reached according to the one or more embodiments as described herein. As depicted in FIG. 4, the visual representation 400 of visual twin 300 includes all eight features of (1) chassis (i.e., frame), (2) engine, (3) body (4) wheels, (5) hood, (6) doors, (7) side mirrors, (8) headlights. Because the engine and chassis are under the body and hood, the engine and chassis are obstructed in the visual representation 400 of visual twin 300. Based on the DTG module 118 displaying visual representation 400 of the pickup truck with all features on client device 110, John Doe can see what the pickup truck should look like when he accumulates an amount that is equal to the financial goal amount of $80,000.

FIG. 4 also includes the input information 405 of the current value of the accumulation value, the financial goal amount, and the start and end date. FIG. 4 further includes a listing 410 of the visual features included in the visual representation. As a result, the display of FIG. 4 can allow the customer to understand the different parameters and characteristics associated with the generated digital twin 300.

Referring back to FIG. 2, the procedure continues from step 225 to step 230. At step 230, the DTG module 118 receives an indication as to whether the visual representation of the visual twin is acceptable or not acceptable.

For example, John Doe may utilize an input device (e.g., mouse and/or keyboard) to hover over the visual representation 400 for the pickup truck to highlight or select each of the eight different visual features. For example, when John Doe uses his mouse to put the cursor over the wheels on the visual representation 400, the wheels of the pickup truck may be highlighted while the other features may be de-emphasized in the visual representation 400. As a result, John Doe can further investigate the particularities of the visual representation 400 of the digital twin 300 to determine if the visual representation and the visual features are to John Doe's liking or not.

If at step 230 an indication is received that indicates that the visual representation of the digital twin 300 is not acceptable, the procedure continues from step 230 to step 235. At step 235, the DTG module 118 updates the visual representation of the digital twin 300.

For example, John Doe may utilize client device 110 to indicate that more or less visual features should be included for the visual representation. Based on said input from client device 110, DTG module 118 may change the dividing portion such that the total number of visual features for the visual representation 400 changes. For example, perhaps John Doe wants the visual representation 400 of the digital twin 300 to include more visual features so that small incremental advances towards the financial goal are captured when the visual representation is displayed.

Therefore, John Doe may indicate to DTG module 118, using the client device 110, that the number of visual features should be increased. The DTG module 118 may communicate with the generative AI model 119 that can, for example, change the dividing factor to 16 such that there are sixteen $ 5,000 portions corresponding to the pickup truck. As such, the DTG module 118 can include an additional visual feature to the displayed visual representation at each $5,000 increment towards the financial goal amount of $80,000.

After the visual representation of the digital twin 300 is updated, the procedure reverts from step 235 to step 230. As such, the digital twin 300 is adjusted/changed until the visual representation of the digital twin 300 is acceptable to the customer.

Once the visual representation of the digital twin is acceptable, the procedure continues from step 230 to step 240. At step 240, the digital twin 300 is stored. For example, the digital twin 300 may be stored in enterprise storage 122. The procedure then ends at step 245.

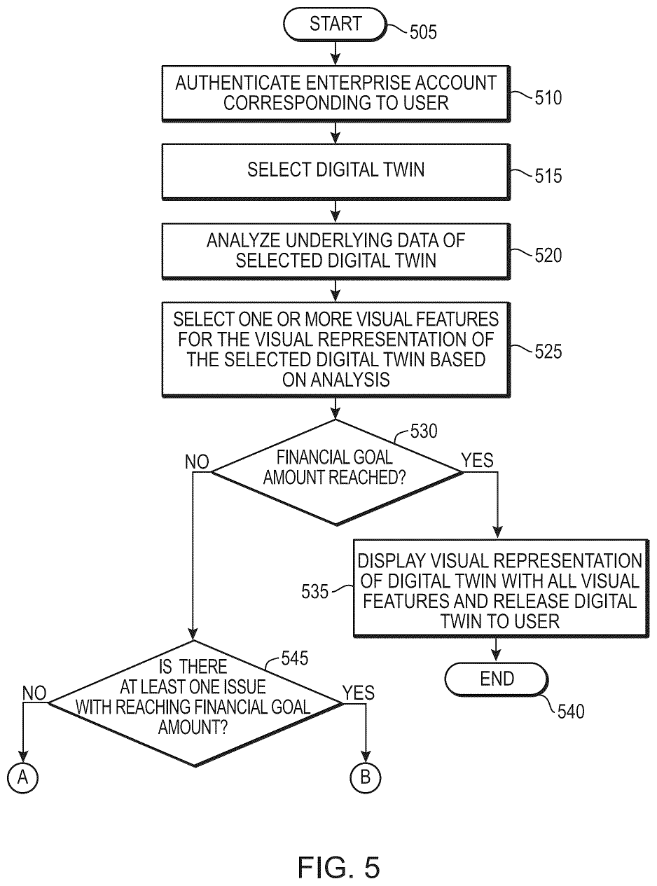

As will be described in further detail below in relation to the flow diagram of FIGS. 5-7, the DTG module 118 can analyze the underlying data of the digital twin 300 and other factors related to the customer/asset to determine which visual features are included when the visual representation of the asset is displayed on the display screen of client device 110. Additionally, the DTG module 118 may, based on the analysis, supplement the visual representation with other graphics and/or markings that can be utilized for incentivization or to convey other meanings.

FIGS. 5, 6, and 7 together are a flow diagram of a sequence of steps for analyzing underlying data of a digital twin and other information to determine how a visual representation of the digital twin is displayed according to the one or more embodiments as described herein.

The procedure starts at step 505 and continues to step 510. At step 510, an account corresponding to a user (i.e., customer) is authenticated with an enterprise system 126. In an embodiment, a customer of the enterprise may utilize client device 110 to first provide authentication information (e.g., username and password) to gain access to the enterprise system 126 as described above in relation to step 210 of FIG. 2. For this example, let it be assumed that John Doe authenticates his account with enterprise system 126 to obtain access on Apr. 15, 2024.

The procedure continues from step 510 to step 515. At step 515, the DTG module 118 selects a digital twin. For example, after authentication, John Doe may utilize application 125 executing on client device 100 to identify all the different digital twins that have been generated for John Doe according to the one or more embodiments as described herein. John Doe may then utilize a pointing device of client device 100 to select a particular digital twin from the list that is presented on application 125. For this example, let it be assumed that John Doe utilizes the pointing device to select digital twin 300 for the pickup truck.

The procedure continues from step 515 to step 520. At step 520, the DTG module 118 analyzes the underlying data of the selected digital twin. For this example, the DTG module 118 analyzes the underlying data in section 310 of digital twin 300 since John Doe selected digital twin 300 in step 515. In an embodiment, the DTG module 118 may compare the accumulation value to the financial goal amount to determine a difference value.

For this example, let it be assumed that on Apr. 15, 2024, John Doe has accumulated, in a particular account managed by the enterprise system 126, $22,500 toward the pickup truck. The DTG module 118 may compare the accumulation value of $22,500 to the financial goal amount of $80,000. The DTG module 118 may evaluate the difference between the values in relation to the start date of Feb. 1, 2024, and end date of Oct. 1, 2024, to determine if the progress made by John Doe of $22,500 by Apr. 15, 2024, indicates sufficient progress, insufficient progress, or progress that exceeds expectations. In an embodiment, the DTG module 118 may compare the difference to a threshold value. If the difference is greater than the threshold value, the DTG module 118 may determine that the progress is insufficient. However, if the difference is less than or equal to the threshold value, the DTG module 118 may determine that the progress is sufficient or the exceeds expectations.

For this example, the visual representation 400 of the digital twin is divided into eight portions, each portion corresponding to $10,000. Therefore, John Doe is expected to accumulate $10,000 per month to stay on track to reach the financial goal amount of $80,000. Therefore, and at the of two months, John Doe would be expected to accumulate $20,000. Therefore, the threshold value may be $60,000, which is the financial goal amount minus the expected accumulation amount. According to the one or more embodiments as described herein, the threshold value may change based on the time at which the evaluation is occurring.

In this example, John Doe has accumulated $22,500 in two months, which puts John Doe on track to accumulate $ 80,000 by the end date of Oct. 1, 2024. For example, if John Doe continues to accumulate finances similarly over the remaining 6 months, John Doe will accumulate the $80,000 to purchase the pickup truck. Further, the difference between the financial goal amount of $80,000 and the accumulated amount of $22,500 is $57,500. Since $57,500 is less than the threshold value of $60,000, the DTG module 118 does not determine that John Doe's progress is insufficient. Instead, the DTG module 118 determines that John Doe's progress towards the financial goal amount is sufficiently on target.

As a further example, let it be assumed that John Doe accumulated $60,000 by Apr. 15, 2024. In this example, John Doe would reach the financial goal amount well before the end of Oct. 1, 2024, if he continued to accumulate finances in a similar manner over the remaining 6 months. Further, the difference between the financial goal amount of $80,000 and the accumulated amount of $60,000 is $20,000. Since $20,000 is less than the threshold value of $60,000, the DTG module 118 does not determine that John Doe's progress is insufficient. Instead, the DTG module 118 can determine that John Doe's progress towards the financial goal amount is exceeding expectations.

As an even further example, let it be assumed that John Doe only accumulated $1,000 by Apr. 15, 2024. In this alternative example, John Doe would not reach the financial goal amount of $80,000 by the end date of Oct. 1, 2024, if he continued to accumulate finances in a similar manner over the remaining 6 months. Further, the difference between the financial goal amount of $80,000 and the accumulated amount of $1,000 is $79,000. Since $79,000 is greater than the threshold value of $60,000, the DTG module 118 determines that John Doe's progress is insufficient and not on target. Referring back to FIG. 5, the procedure continues from step 520 to step 525. At step 525, one or more visual features selected for the visual representation of the selected digital twin based on the analysis. For this example, the chassis is the default visual feature when the digital twin 300 is generated. Therefore, and at step 520, one or more other visual features of the remaining seven visual features are selected based on the analysis. Specifically, and based on the analysis, the DTG module 118 may select the features or the DTG module 118 may communicate with the generative AI model 119 that can select the features.

For example, when the accumulation value is $22,500 on Apr. 15, 2024, the DTG module 118 may determine that the accumulation value of $22,500 is equivalent to two $10,000 portions and ¼ of a third $ 10,000 portion. As such, two additional visual features of the remaining seven visual features are selected. When the accumulation amount is $11,000 on Apr. 15, 2024, the DTG module 118 may determine that the accumulation value of $11,000 is equivalent to one $10,000 portion and 1/10^{th} of a second $10,000 portion. As such, one additional visual feature of the remaining seven visual features is selected. When the accumulation amount is $50,000 on Apr. 15, 2024, the DTG module 118 may determine that the accumulation value of $50,000 is equivalent to exactly five $10,000 portions. As such, four additional visual feature of the seven remaining visual features are selected.

In an embodiment, and to select a particular feature, the DTG module 118 or the generative AI model 119 may include a true value in the included field 304 for the particular visual feature. For example, let it be assumed that the two additional visual features of the engine and the body are selected when the accumulation value is $22,500. Therefore, the DTG module 118 or the generative AI model 119 may access section 301C that corresponds to the engine visual feature and store a value of true in included field 305B. Similarly, the DTG module 118 or the generative AI model 119 may access section 301D that corresponds to the body visual feature and store a value of true in included field 305C. Therefore, and for this example, included field 305A, for the default chassis visual feature has a value of true. Additionally, included fields 305B and 305C corresponding to the engine and body visual features also have a value of true. Other included fields 305D-305H for the other visual features have a value of false.

The procedure continues from step 525 to step 530. At step 530, the DTG module 118 determines if the financial goal amount has been reached. In an embodiment, the DTG module 118 may compare the accumulation value to the financial goal amount. If the two values are equal, the DTG module 118 determines that the financial goal amount has been reached.

If the financial goal amount has been reached at step 530, the procedure continues to step 535. At step 535, the DTG module 118 displays the visual representation of the digital twin 300 with all the visual features and releases the digital twin 300 to the user (e.g., customer). In an embodiment, the generative AI model 119 may evaluate the included fields (305A-305H) of each visual feature in digital twin 300 to determine which features (i.e., components) are selected. The generative AI model 119 may then generate the visual representation with the selected features such that the selected features have their accurate proportions and spatial relationships. As such, and in this example, the generative AI model 119 generates a visual representation of the pickup truck with all the components, where these components have accurate portions and spatial relationships in the visual representation. The generative AI model 119 may then provide the generated visual representation to the DTG module 118.

The DTG module 118 may display the visual representation with all the visual features on the client device 110. For the example as described herein, the DTG module 118 may display visual representation 400 of FIG. 4 and corresponding to digital twin 300 for the pickup truck, wherein the visual representation 400 includes all eight features of (1) chassis (i.e., frame), (2) engine, (3) body (4) wheels, (5) hood, (6) doors, (7) side mirrors, (8) headlights. In an embodiment, the DTG module 118 displays the visual representation 400 of the pickup truck without the input information 405 and the listing 410 of the features.

The DTG module 118 may also transmit the digital twin 300 with the visual representation 400 and underlying data to the client device 110 such that the customer can share and export the digital twin via other platforms such as social media platforms. Thus, and when the financial goal amount is reached, the customer has unlimited access to the digital twin asset and can share and export the digital twin 300 as desired. In an embodiment, and when the digital twin 300 is released to the customer, the customer owns the digital twin 300. The procedure then continues from step 535 to step 540 where the procedure ends.

If the financial goal amount is not reached at step 530, the procedure continues to step 545. At step 545, the DTG module 118 determines if there is at least one issue with reaching the financial goal amount. The DTG module 118 may determine that there is an issue with reaching the financial goal amount based on, for example, an analysis of customers records and/or one or more external factors associated with the customer.

As an example, let it be assumed that the DTG module 118 analyzes one or more financial records associated with John Doe and determines that John Doe had to unexpectedly spend $10,000 on repairing the roof of his home. The DTG module 118 may determine, for example, the reason for John Doe's insufficient progress is tied to the unexpected repair.

As another example, let it be assumed that the DTG module 118 analyzes one or more records for John Doe and determines that John Doe lives in Miami, Florida. Further, let it be assumed that the DTG module 118 analyzes current news information and determines that Miami, Florida encountered a hurricane on Apr. 14, 2024. Therefore, although John Doe's progress may not be insufficient at this time, the DTG module 118 may anticipate that the progress may be stifled become insufficient because of the hurricane.

The examples of the roof repair and the hurricane are for illustrative purposes only, and it is expressly contemplated that the DTG module 118 may identify any of a variety of issues based on an analysis of any factors that may be associated with the customer and/or asset.

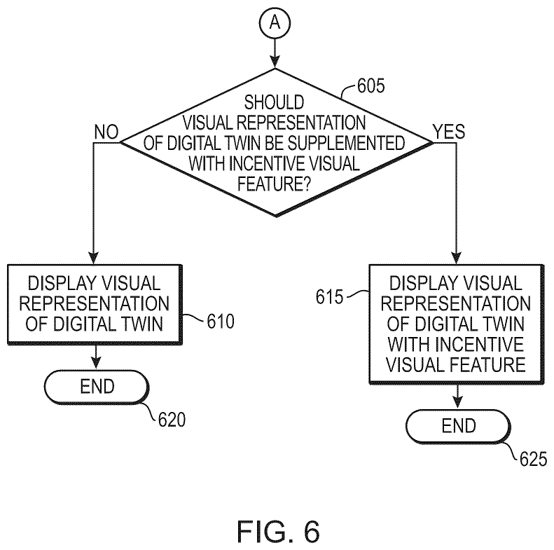

If at step 545 the DTG module 118 determines that there is not at least one issue in reaching the financial goal, the procedure continues from step 545 to step 605 of FIG. 6. At step 605, the DTG module 118 determines if the visual representation of digital twin should be supplemented with an incentive visual feature. In an embodiment, the DTG module 118 determines that the visual representation of the digital twin should be supplemented with an incentive visual feature if the DTG module 118 determines that the progress towards the financial goal amount is insufficient. For example, the DTG module 118 may determine that the visual representation should be supplemented with an incentive visual feature when the difference between the accumulation value and the financial goal amount is equal to or greater than an incentive threshold value. In an alternative embodiment, the DTG module 118 may determine that the visual representation should be supplemented with the incentive visual feature based on received input from client device 110. For example, John Doe may utilize client device 110 to indicate that an issue has arisen and identify the issue, or John Doe's financial advisor may utilize client device 110 to indicate that the issue has arisen and identify the issue. This information can then be provided to the DTG module 118.

If the DTG module 118 determines that the visual representation should not be supplemented with an incentive visual feature, the procedure continues from step 605 to step 610. At step 610, the DTG module 118 displays the visual representation of the digital twin.

In an embodiment, and prior to displaying the visual representation, the generative AI model 119 may evaluate the included fields (305A-305H) of each visual feature in digital twin 300 to determine which features (i.e., components) are selected. The generative AI model 119 may then generate the visual representation with the selected features such that the selected features have their accurate proportions and spatial relationships. For this example, let it be assumed that the included fields (e.g., 305A, 305B, and 305C) for the chassis, engine, and body have a value of true, while the other included fields (e.g., 305D-305H) have a value of false. As such, the generative AI model 119 generates a visual representation of the pickup truck with the chassis, engine, and body, where these components have accurate portions and spatial relationships in the visual representation. The generative AI model 119 may then provide the generated visual representation to the DTG module 118.

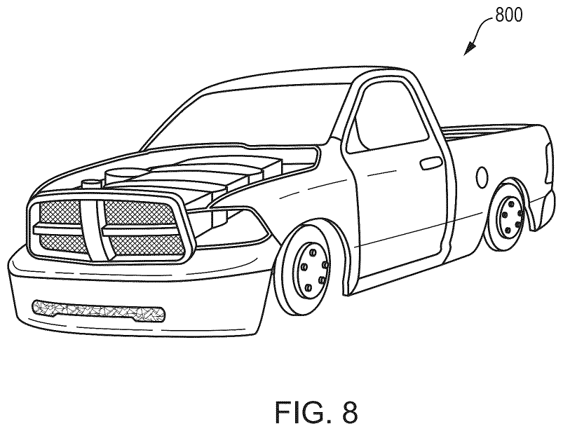

FIG. 8 is an example visual representation of digital twin 300 for the pickup truck without an incentive visual feature according to the one or more embodiments as described herein. As depicted in FIG. 8, the visual representation 800 of visual twin 300 for the pickup truck includes the chassis, engine, and body. Most of the chassis as depicted in FIG. 8 is covered by the body. The visual features of the wheels, hood, doors, side mirrors, and headlights are not included in visual representation 800. The display of visual representation 800 of the pickup truck allows John Doe to visualize his progress toward the financial goal amount for purchasing the pickup truck. The procedure continues from step 610 to step 620 and ends.

If the DTG module 118 determines that the visual representation should be supplemented with an incentive visual feature, the procedure continues from step 605 to 615. At step 615, the DTG module 118 displays the visual representation of the digital twin with the incentive visual feature.

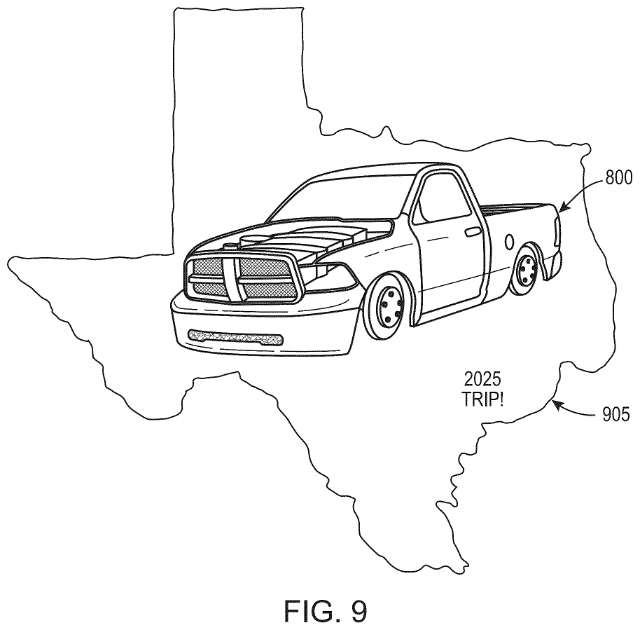

FIG. 9 is an example visual representation of digital twin 300 for the pickup truck with an incentive visual feature according to the one or more embodiments as described herein. The visual representation 800 may be generated by the generative AI model 119 in a similar manner as described above in relation to step 610. For the example of FIG. 9, visual representation 800 of the pickup truck includes the visual features of the chassis, engine, and body. Thus, the visual features of the wheels, hood, doors, side mirrors, and headlights are not included in visual representation 800.

According to the one or more embodiments as described herein, the DTG module 118 may analyze one or more records corresponding to John Doe to identify a meaningful incentive. For example, the DTG module 118 may analyze John Doe's records stored on enterprise storage 122 to determine that John is planning a vacation with his family in Texas in early 2025. As such, the DTG module 118 may obtain a visual feature corresponding to the trip to supplement the visual representation of the pickup up truck. In an embodiment, the DTG module 118 may obtain the visual feature from storage 122 or generative AI model 119. For this example, let it be assumed that the DTG module 118 obtains an outline image 905 of the state of Texas and the text of “2025 Trip!”. Therefore, the DTG module 118 may supplement the visual representation 800 of the pickup truck with the outline image 905 of the state of Texas and the text 910 of “2025 Trip!” to incentivize John Doe to reach his goal so that he can utilize the pickup truck when he takes his family trip to Texas in early 2025. In an embodiment, the outline image 905 of the state of Texas and the text of “2025 Trip!” may be included in digital twin 300.

Therefore, and according to the one or more embodiments as described herein, the visual representation of the digital twin can be supplemented with an incentive visual feature based on an analysis of data corresponding to the user and/or asset. Thus, the incentive visual feature can be user dependent such that each visual representation of a pickup truck, for example, can be uniquely supplemented for different users. The procedure continues from step 615 to step 625 and ends.

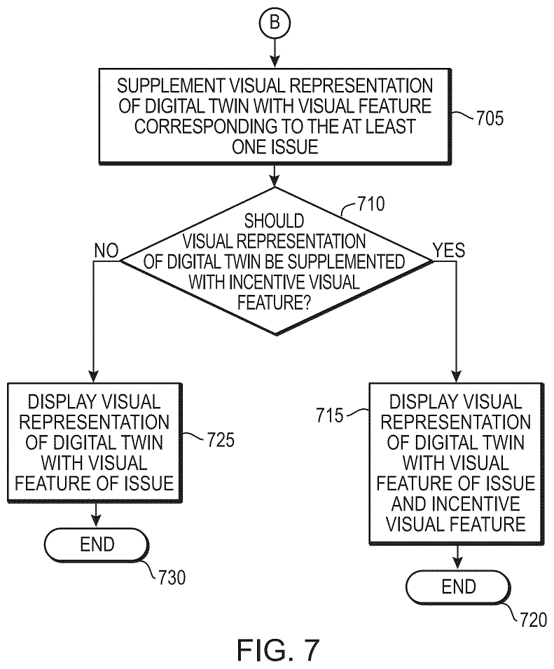

Referring back to FIG. 5, If at step 545 the DTG module 118 determines that there is at least one issue in reaching the financial goal amount, the procedure continues from step 545 to step 705 of FIG. 7. At step 705, the DTG module 118 determines that the visual representation of the digital twin should be supplemented with a visual feature corresponding to the at least one issue.

For example, let it be assumed that the DTG module 118 determines that a hurricane is an issue encountered that can affect John Doe reaching the financial goal amount. As a result, the DTG module 118 may determine that the visual representation of the digital twin 300 for the pickup truck is to be supplemented, when displayed, with a visual feature corresponding to the issue. In an embodiment, the DTG module 118 may obtain the visual feature corresponding to the issue from enterprise storage 122 or from generative AI model 119. For example, the DTG module 118 may search and identify a visual feature corresponding to a hurricane. For this example, let it be assumed that the visual feature identified by the DTG module 118 is text that states “HURRICANE.”.

The procedure continues from step 705 to step 710. At step 710, the DTG module 118 determines whether an incentive visual feature should be used to supplement the visual representation of the digital twin with an incentive visual feature. In an embodiment, the DTG module 118 determines whether the visual representation should be supplemented with the incentive visual feature in a similar manner as described above in relation to step 605 of FIG. 6.

If the DTG module 118 determines that the incentive visual feature should be used to supplement the visual representation, the procedure continues from step 710 to step 715. At step 715, the DTG module 118 display the visual representation of the digital twin 300 with the visual feature of the issue and the incentive visual feature.

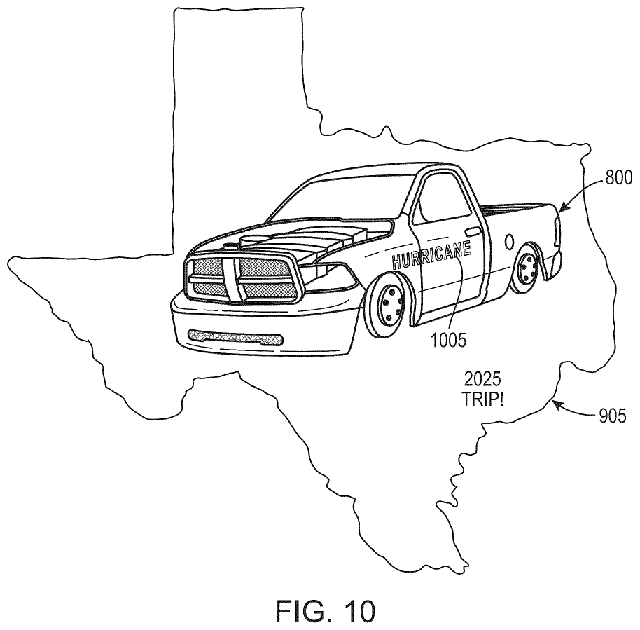

FIG. 10 is an example visual representation of digital twin 300 for the pickup truck with a visual feature of an issue and an incentive visual feature according to the one or more embodiments as described herein. For the example of FIG. 10, visual representation 800 of the pickup truck includes the visual features of the chassis, engine, and body. Thus, the visual features of the wheels, hood, doors, side mirrors, and headlights are not included in visual representation 800. Further, and as depicted in FIG. 10, the visual representation includes a visual feature 1005 for the hurricane. Specifically, the visual feature 1005 is the text of “HURRICANE” that is on the side of the pickup truck. Moreover, and as depicted in FIG. 10, the visual representation 800 of the pickup truck is supplemented with the outline image 905 of the state of Texas to incentivize John Doe to reach his goal so that he can utilize the pickup truck when he takes his family trip to Texas in early 2025. The procedure continues from step 715 to step 720 and ends.

Referring back to FIG. 7, If the DTG module 118 determines that the incentive visual feature should not be used to supplement the visual representation, the procedure continues from step 710 to step 725. At step 725, the DTG module 118 display the visual representation of the digital twin 300 with the visual feature of the issue.

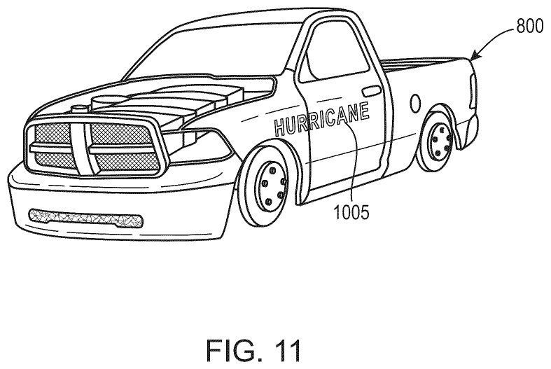

FIG. 11 is an example visual representation of digital twin 300 for the pickup truck with a visual feature of an issue according to the one or more embodiments as described herein. For the example of FIG. 11, visual representation 800 of the pickup truck includes the visual features of the chassis, engine, and body. Thus, the visual features of the wheels, hood, doors, side mirrors, and headlights are not included in visual representation 800. Further, and as depicted in FIG. 11, the visual representation includes a visual feature 1005 for the hurricane. Specifically, the visual feature 1005 is the text of “HURRICANE” that is on the side of the pickup truck. The procedure continues from step 725 to step 730 and ends.

It should be understood that a wide variety of adaptations and modifications may be made to the techniques. For example, the steps of the flow diagrams as described herein may be performed sequentially, in parallel, or in one or more varied orders. In general, functionality may be implemented in software, hardware or various combinations thereof. Software implementations may include electronic device-executable instructions (e.g., computer-executable instructions) stored in a non-transitory electronic device-readable medium (e.g., a non-transitory computer-readable medium), such as a volatile memory, a persistent storage device, or other tangible medium. Additionally, it should be understood that the term user and customer may be used interchangeably. Hardware implementations may include logic circuits, application specific integrated circuits, and/or other types of hardware components. Further, combined software/hardware implementations may include both electronic device-executable instructions stored in a non-transitory electronic device-readable medium, as well as one or more hardware components. Above all, it should be understood that the above description is meant to be taken only by way of example.

1. A computer-implemented method for generating an electronic digital twin of an asset and that includes underlying data that dictates how a graphical representation of the electronic digital twin is displayed, the method comprising:
receiving, at a processor of a computing device, input information associated with an asset of interest to a user, wherein the input information includes at least a financial goal amount for obtaining the asset;
providing the input information to a generative artificial intelligence (AI) model;
generating, by the generative AI model, a digital twin for the asset, wherein generating the digital twin comprises:
generating or obtaining a visual representation of the asset,
linking the input information to the visual representation of the asset, and
dividing the visual representation for the asset into a plurality of different visual features based on at least the financial goal amount corresponding to the asset;
analyzing, by the processor, one or more records corresponding to at least one of the user and the asset;
determining, based on the analyzing, an accumulation value for obtaining the asset;
comparing the accumulation value with the financial goal amount;
selecting, based on the comparison, one or more of the plurality of different visual features to determine selected visual features and non-selected visual features for the visual representation of the asset, wherein a number of the selected visual features and a number of the non-selected visual features change as a difference between the accumulation value and the financial goal amount changes; and
displaying, on a computer display, the visual representation of the asset that corresponds to the digital twin, wherein the visual representation is displayed with the selected visual features and without the non-selected visual features.

2. The computer-implemented method of claim 1, further comprising:
determining, based on the analyzing, that an external factor has negatively impact the accumulation value from reaching the financial goal amount; and
supplementing the display of the visual representation of the asset corresponding to the digital twin with an external visual representation of the external factor.

3. The computer-implemented method of claim 1, further comprising:
determining, based on the analyzing, a different asset of interest to the user; and
supplementing the display of the visual representation of the asset corresponding to the digital twin with an incentive visual representation of the different asset of interest to the user.

4. The computer-implemented method of claim 1, further comprising:
determining that the accumulation value has increased towards the financial goal amount;
increasing the number of the selected visual features to determine updated selected visual features and decreasing the number of the non-selected visual features to determine updated non-selected visual features; and
displaying, on the computer display, the visual representation of the asset that corresponds to the digital twin, wherein the visual representation is displayed with the updated selected visual features and without the updated non-selected visual features.

5. The computer-implemented method of claim 1, further comprising:
determining that the accumulation value has decreased away from the financial goal amount;
decreasing the number of the selected visual features to determine updated selected visual features and increasing the number of the non-selected visual features to determine updated non-selected visual features; and
displaying, on the computer display, the visual representation of the asset that corresponds to the digital twin, wherein the visual representation is displayed with the updated selected visual features and without the updated non-selected visual features.

6. The computer-implemented method of claim 1, further comprising:
determining that the accumulation value has not changed;
determining that the financial goal amount has changed;
changing the number of the selected visual features and the number of non-selected visual features to determine updated selected visual features and updated non-selected visual features; and
displaying, on the computer display, the visual representation of the asset that corresponds to the digital twin, wherein the visual representation is displayed with the updated selected visual features and without the updated non-selected visual features.

7. The computer-implemented method of claim 1, further comprising:
determining that the accumulation value equals the financial goal amount;
determining that the selected visual features includes all of the plurality of different visual features; and
displaying, on the computer display, the visual representation of the asset that corresponds to the digital twin, wherein the visual representation is displayed with all of the plurality of different visual features.

8. The computer-implemented method of claim 1, wherein the visual representation is one of a (1) a two-dimensional graphical depiction of the asset, (2) a three-dimensional graphical depiction of the asset, (3) an augmented reality model that includes a graphical depiction of asset, or (4) a virtual reality model that includes the graphical depiction of the asset.

9. The computer-implemented method of claim 1, wherein the input information includes a start date indicating a first date on which the user will start contributing towards the financial goal amount and an end date indicating a second date on which the user would like to reach the financial goal amount.

10. A system for generating an electronic digital twin of an asset and that includes underlying data that dictates how a graphical representation of the electronic digital twin is displayed, the system comprising:
a processor coupled to a memory, the processor executing a software module configured to:
receive input information associated with an asset of interest to a user, wherein the input information includes at least a financial goal amount for obtaining the asset;
generate, using a generative artificial intelligence (AI) model, a digital twin for the asset, wherein the software module, in generating the digital twin, is further configured to:
generate or obtaining a visual representation of the asset,
link the input information to the visual representation of the asset, and
divide the visual representation for the asset into a plurality of different visual features based on at least the financial goal amount corresponding to the asset;
analyze one or more records corresponding to at least one of the user and the asset;
determine, based on the analyzing, an accumulation value for obtaining the asset;
compare the accumulation value with the financial goal amount;
select, based on the comparison, one or more of the plurality of different visual features to determine selected visual features and non-selected visual features for the visual representation of the asset, wherein a number of the selected visual features and a number of the non-selected visual features change as a difference between the accumulation value and the financial goal amount changes; and
display, on a computer display, the visual representation of the asset that corresponds to the digital twin, wherein the visual representation is displayed with the selected visual features and without the non-selected visual features.

11. The system of claim 10, wherein the software module is further configured to:
determine, based on the analyzing, that an external factor has negatively impact the accumulation value from reaching the financial goal amount; and
supplement the display of the visual representation of the asset corresponding to the digital twin with an external visual representation of the external factor.

12. The system of claim 10, wherein the software module is further configured to:
determine, based on the analyzing, a different asset of interest to the user; and
supplement the display of the visual representation of the asset corresponding to the digital twin with an incentive visual representation of the different asset of interest to the user.

13. The system of claim 10, wherein the software module is further configured to:
determine that the accumulation value has increased towards the financial goal amount;
increase the number of the selected visual features to determine updated selected visual features and decreasing the number of the non-selected visual features to determine updated non-selected visual features; and
display, on a computer display, the visual representation of the asset that corresponds to the digital twin, wherein the visual representation is displayed with the updated selected visual features and without the updated non-selected visual features.

14. The system of claim 10, wherein the software module is further configured to:
determine that the accumulation value has decreased away from the financial goal amount;
decrease the number of the selected visual features to determine updated selected visual features and increasing the number of the non-selected visual features to determine updated non-selected visual features; and
display, on a computer display, the visual representation of the asset that corresponds to the digital twin, wherein the visual representation is displayed with the updated selected visual features and without the updated non-selected visual features.

15. The system of claim 10, wherein the software module is further configured to:
determine that the accumulation value has not changed;
determine that the financial goal amount has changed;
change the number of the selected visual features and the number of non-selected visual features to determine updated selected visual features and updated non-selected visual features; and
display, on a computer display, the visual representation of the asset that corresponds to the digital twin, wherein the visual representation is displayed with the updated selected visual features and without the updated non-selected visual features.

16. The system of claim 10, wherein the software module is further configured to:
determine that the accumulation value equals the financial goal amount;
determine that the selected visual features includes all of the plurality of different visual features; and
display, on a computer display, the visual representation of the asset that corresponds to the digital twin, wherein the visual representation is displayed with all of the plurality of different visual features.

17. The system of claim 10, wherein the visual representation is one of a (1) a two-dimensional graphical depiction of the asset, (2) a three-dimensional graphical depiction of the asset, (3) an augmented reality model that includes a graphical depiction of asset, or (4) a virtual reality model that includes the graphical depiction of the asset.

18. The system of claim 10, wherein the input information includes a start date indicating a first date on which the user will start contributing towards the financial goal amount and an end date indicating a second date on which the user would like to reach the financial goal amount.

19. A non-transitory computer readable medium having software encoded thereon, the software when executed by one or more computing devices operable to:
receive input information associated with an asset of interest to a user, wherein the input information includes at least a financial goal amount for obtaining the asset;
generate, using a generative artificial intelligence (AI) model, a digital twin for the asset, wherein the software is further configured to:
generate or obtaining a visual representation of the asset,
link the input information to the visual representation of the asset, and
a divide the visual representation for the asset into a plurality of different visual features based on at least the financial goal amount corresponding to the asset;
analyze one or more records corresponding to at least one of the user and the asset;
determine, based on the analyzing, an accumulation value for obtaining the asset;
compare the accumulation value with the financial goal amount;
select, based on the comparison, one or more of the plurality of different visual features to determine selected visual features and non-selected visual features for the visual representation of the asset, wherein a number of the selected visual features and a number of the non-selected visual features change as a difference between the accumulation value and the financial goal amount changes; and
display, on a computer display, the visual representation of the asset that corresponds to the digital twin, wherein the visual representation is displayed with the selected visual features and without the non-selected visual features.

20. The non-transitory computer readable medium of claim 19, wherein the software is further configured to:
determine, based on the analyzing, that an external factor has negatively impact the accumulation value from reaching the financial goal amount; and
supplement the display of the visual representation of the asset corresponding to the digital twin with an external visual representation of the external factor.
